(19) United States
(12) Patent Application Publication
(10) Pub. No.: US 2024/0114964 A1
(43) Pub. Date: Apr. 11, 2024

(54) Heating Apparatus for an Aerosol Generating Device

(71) Applicant: JT International SA, Geneva (CH)

(72) Inventor: Herman Hijma, Kampen (NL)

(73) Assignee: JT International SA, Geneva (CH)

(21) Appl. No.: 18/273,669

(22) PCT Filed: Jan. 26, 2022
(86) PCT No.: PCT/EP2022/051801

§ 371 Date: Jul. 21, 2023

(30) Foreign Application Priority Data
Feb. 2, 2021 (EP) 21154763.3

(51) Int. Cl. A24F 40/465; A24F 40/20; A24F 40/70; H05B 6/10

(52) U.S. Cl. CPC A24F 40/465; A24F 40/20; A24F 40/70; H05B 6/108

(57) ABSTRACT

A heating apparatus for an aerosol generating device is disclosed. The heating apparatus comprises a first casing member, a second casing member, and one or more inductively heatable susceptors. The first casing member, the second casing member and the one or more inductively heatable susceptors cooperatively engage to form a tubular heating chamber for receiving at least part of an aerosol generating substrate. The one or more inductively heatable susceptors are arranged to couple the first casing member to the second casing member.

### FIELD OF THE INVENTION

The present invention relates to a heating apparatus for an aerosol generating device, a method of manufacturing a heating assembly for an aerosol generating device, and an aerosol generating device. The disclosure is particularly applicable to a portable aerosol generating device, which may be self-contained and low temperature. Such devices may heat, rather than burn, tobacco or other suitable aerosol substrate materials by conduction, convection, and/or radiation, to generate an aerosol for inhalation.

### BACKGROUND

The popularity and use of reduced-risk or modified-risk devices (also known as vaporisers) has grown rapidly in the past few years as an aid to assist habitual smokers wishing to quit using traditional tobacco products such as cigarettes, cigars, cigarillos, and rolling tobacco. Various devices and systems are available that heat or warm aerosolisable substances as opposed to burning tobacco in conventional tobacco products.

A commonly available reduced-risk or modified-risk device is the heated substrate aerosol generation device or heat-not-burn device. Devices of this type generate an aerosol or vapour by heating an aerosol substrate (i.e. consumable) that typically comprises moist leaf tobacco or other suitable aerosolisable material to a temperature typically in the range of 150° C. to 300° C. Heating an aerosol substrate, but not combusting or burning it, releases an aerosol that comprises the components sought by the user but not the undesirable by-products of combustion. In addition, the aerosol produced by heating the tobacco or other aerosolisable material does not typically comprise the burnt or bitter taste that may result from combustion that can be unpleasant for the user.

Currently available aerosol generating devices can use one of a number of different approaches to provide heat to the aerosol generating substrate. One such approach is to provide an aerosol generating device which employs an induction heating system. In such a device, an induction coil is provided in the device and an inductively heatable susceptor is provided to heat the aerosol generating substrate. Electrical energy is supplied to the induction coil when a user activates the device which in turn generates an alternating electromagnetic field. The susceptor couples with the electromagnetic field and generates heat which is transferred, for example by conduction, to the aerosol generating substrate and an aerosol is generated as the aerosol generating substrate is heated.

However, within such devices, the use of susceptors which are attached to the heating chamber often leads to a bulky aerosol generating device. Therefore, an object of the present invention is to provide a compact heating apparatus, which is able to efficiently heat an aerosol generating substrate.

### SUMMARY OF THE INVENTION

According to a first aspect of the invention, there is provided a heating apparatus for an aerosol generating device, comprising: a first casing member; a second casing member; and one or more inductively heatable susceptors, wherein the first casing member, the second casing member and the one or more inductively heatable susceptors cooperatively engage to form a heating chamber for receiving at least part of an aerosol generating substrate.

In this way, as the inductively heatable susceptors form part of the heating chamber, rather than being attached onto or within the heating chamber, a more compact heating apparatus is provided. The inductively heatable susceptors cooperatively engage with the first casing member and the second casing member, which enables the inductively heatable susceptors to be optimally positioned for heating the aerosol generating substrate received within the heating chamber, without increasing the bulkiness of the heating apparatus.

Preferably, the one or more inductively heatable susceptors are arranged to couple the first casing member to the second casing member. In this way, the inductively heatable susceptors have a dual purpose of heating the aerosol generating substrate received within the heating chamber, whilst also ensuring the heating apparatus is structurally secure. In other words, the inductively heatable susceptors acts as fastening elements which secure the first casing member to the second casing member, which enables the inductively heatable susceptors to be integrated within the heating chamber, thereby providing a compact heating apparatus. The ease of manufacturing the heating apparatus may also be improved.

Preferably, the one or more inductively heatable susceptors engage with the first casing member and the second casing member such that the first casing member, the second casing member and the one or more inductively heatable susceptors are rotationally locked with respect to one another. In this way, the durability of the heating apparatus is further improved without adversely affecting the compactness of the heating apparatus. As aerosol generating devices are portable and may be roughly handled by a user, ensuring the heating apparatus has a high durability is particularly advantageous.

Preferably, the one or more inductively heatable susceptors are formed as elongate rods that are integrated within a wall of the heating chamber, wherein the one or more inductively heatable susceptors are spaced around the heating chamber and extend in a direction that is parallel to a longitudinal axis of the heating chamber. In this way, the inductively heatable susceptors provide a concentrated heating effect along the length of the aerosol substrate received within the heating chamber, whilst also providing a compact heating apparatus. The aerosol generating substrate is heated rapidly and uniformly by the inductively heatable susceptors spaced around the heating chamber.

Preferably, the one or more inductively heatable susceptors are formed as curved plates that are integrated within a wall of the heating chamber, wherein the one or more inductively heatable susceptors are spaced around the heating chamber and extend in direction that is parallel to a longitudinal axis of the heating chamber. In this way, the inductively heatable susceptors provide a large surface area for heating the aerosol substrate received within the heating chamber, whilst also providing a compact heating apparatus. The aerosol generating substrate is heated rapidly and uniformly by the inductively heatable susceptors spaced around the heating chamber.

Preferably, the one or more inductively heatable susceptors respectively comprise at least one inwardly extending portion that protrudes into the heating chamber to provide a reduced cross-sectional area of the heating chamber such that, in use, the aerosol generating substrate received within the heating chamber is compressed. In this way, by compressing the aerosol generating substrate, heat can be transferred more efficiently to the aerosol generating substrate and more rapid heating can be achieved, whilst at the same time maximising energy efficiency.

Preferably, the one or more inductively heatable susceptors respectively comprise at least one outwardly extending portion that protrudes out of the heating chamber to increase the mass of the one or more inductively heatable susceptors that may be inductively heated. In this way, a greater mass of inductively heatable susceptors is provided away from the centre of the heating chamber (i.e. in closer proximity to a surrounding induction coil). This improves the capability of the inductively heatable susceptors to harvest electromagnetic energy from the induction coil.

Preferably, the at least one outwardly extending portion of the one or more inductively heatable susceptors extend radially outwardly with respect to the outer circumferential edges of the first and second casing members.

Preferably, the first casing member is substantially tubular and comprises a first longitudinal end, wherein the second casing member is substantially tubular and comprises a second longitudinal end, and wherein the first casing member and the second casing member are coaxially aligned with the first longitudinal end of the first casing member adjacent to the second longitudinal end of the second casing member. In this way, a compact heating chamber is provided that is configured to receive a substantially cylindrical aerosol generating substrate. This may be advantageous as aerosol generating substrates, in the form of aerosol generating articles, are often packaged and sold in a cylindrical form.

Preferably, the first longitudinal end of the first casing member has a slotted configuration comprising one or more slots, and wherein the one or more inductively heatable susceptors are respectively located within the one or more slots. In this way, the one or more inductively heatable susceptors are provided in close proximity to the aerosol generating substrate received within the heating chamber, without increasing the bulkiness of the device. Moreover, the ease of manufacturing the heating apparatus may be improved.

Preferably, the second longitudinal end of the second casing member has a slotted configuration comprising one or more slots, wherein the one or more slots of the first longitudinal end of the first casing member align with the one or more slots of the second longitudinal end of the second casing member, and wherein the one or more inductively heatable susceptors are respectively located within and extend between each pair of aligned slots to couple the first casing member to the second casing member. In this way, the one or more inductively heatable susceptors are provided in close proximity to the aerosol generating substrate received within the heating chamber without increasing the bulkiness of the device, whilst also providing a secure fastening between the first casing member and the second casing member.

Preferably, the heating apparatus further comprises an inductively heatable susceptor ring that is disposed between the first longitudinal end of the first casing member and the second longitudinal end of the second casing member. In this way, a concentrated heating effect may be provided towards the centre of the aerosol generating substrate received within the heating chamber, whilst also providing a compact heating apparatus.

In one example, the one or more inductively heatable susceptors and the inductively heatable susceptor ring may be formed as a single component. In this way, the strength of the coupling between the first casing member and the second casing member may be further improved.

Preferably, the first longitudinal end of the first casing member and the second longitudinal end of the second casing member have complementary slotted configurations such that the first longitudinal end of the first casing member substantially engages with the second longitudinal end of the second casing member so that they are rotationally locked with respect to one another, and wherein the one or more inductively heatable susceptors are respectively located along one or more longitudinal interfaces between the complementary slotted configurations. In this way, the inductively heatable susceptors are able to securely fasten the first casing member to the second casing member whilst being located in an optimal position for heating the aerosol generating substrate received within the heating chamber.

Preferably, the first casing member and the second casing member can be combined along their length to form the heating chamber which is substantially tubular, and wherein the first casing member and the second casing member are clamped together by the one or more inductively heatable susceptors. In this way, a secure arrangement of components is provided which may be easily assembled and disassembled.

Preferably, the one or more inductively heatable susceptors are detachable from the first casing and the second casing. In this way, the inductively heatable susceptors may be removed and replaced, for instance if the material of the inductively heatable susceptors begins to degrade.

Preferably, the heating chamber is substantially tubular. In this way, the heating chamber may be configured to receive a substantially cylindrical aerosol generating substrate which may be advantageous as, often, aerosol generating substrates in the form of aerosol generating articles are packaged and sold in a cylindrical form.

Preferably, the heating apparatus further comprises an induction heating coil that surrounds the heating chamber.

Preferably, wherein the first casing and the second casing comprise a heat-resistant plastics material, preferably polyether ether ketone (PEEK).

According to a second aspect of the invention, there is provided a method of manufacturing a heating assembly, comprising the steps of: providing a first casing member; providing a second casing member; providing one or more inductively heatable susceptors; and cooperatively engaging the first casing member, the second casing member and the one or more inductively heatable susceptors to form a heating chamber for receiving at least part of an aerosol generating substrate.

According to third aspect of the invention, there is provided an aerosol generating device comprising a heating apparatus according to the first aspect.

### BRIEF DESCRIPTION OF THE DRAWINGS

Embodiments of the invention are now described, by way of example, with reference to the drawings, in which:

FIG. 1 is a diagrammatic cross-sectional view of an aerosol generating system comprising an aerosol generating device and an aerosol generating article ready to be positioned in a heating chamber of the aerosol generating device;

FIG. 2 is a diagrammatic cross-sectional view of the aerosol generating system of FIG. 1, showing the aerosol generating article positioned in the heating chamber of the aerosol generating device;

FIGS. 3A to 3C are various schematic views of a heating chamber for the aerosol generating device according to an embodiment of the invention;

FIGS. 4A to 4C are various schematic views of a heating chamber for the aerosol generating device according to an embodiment of the invention;

FIGS. 5A to 5C are various schematic views of a heating chamber for the aerosol generating device according to an embodiment of the invention;

FIGS. 6A to 6B are various schematic views of a heating chamber for the aerosol generating device according to an embodiment of the invention;

FIGS. 7A to 7C are various schematic views of a heating chamber for the aerosol generating device according to an embodiment of the invention;

FIGS. 8A to 8C are various schematic views of a heating chamber for the aerosol generating device according to an embodiment of the invention;

FIGS. 9A to 9C are various schematic views of a heating chamber for the aerosol generating device according to an embodiment of the invention;

FIGS. 10A to 10D are various schematic views of a heating chamber for the aerosol generating device according to an embodiment of the invention;

FIG. 11 is a schematic view of a heating chamber for the aerosol generating device according to an embodiment of the invention, the heating chamber comprising detachable inductively heatable susceptors; and

FIGS. 12A and 12B are schematic views of a heating chamber for the aerosol generating device according to an embodiment of the invention, the heating chamber comprising detachable inductively heatable susceptors.

### DETAILED DESCRIPTION

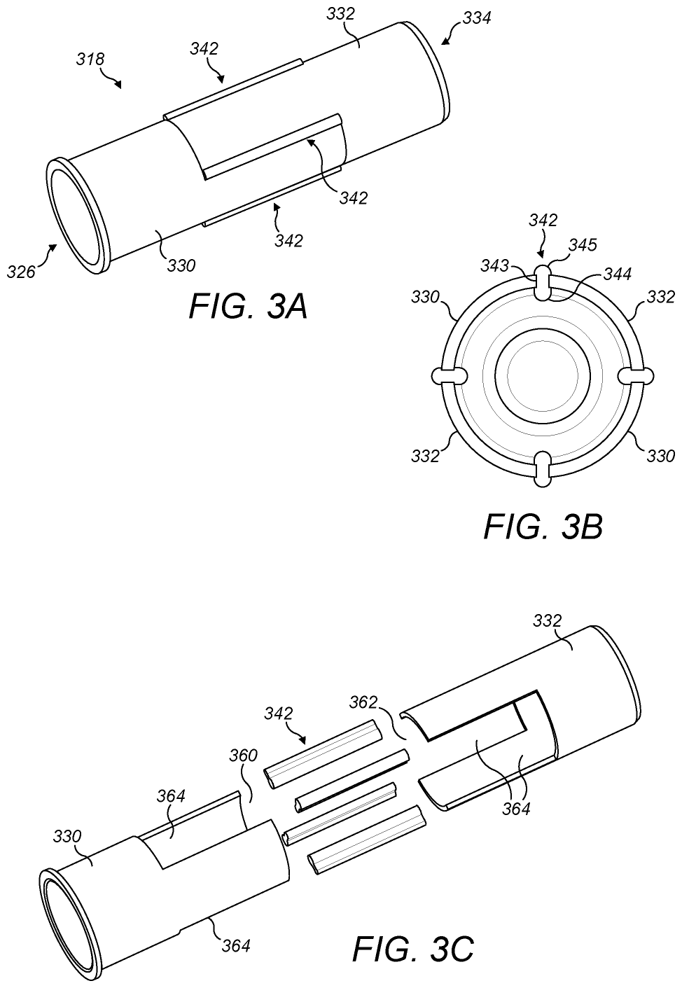

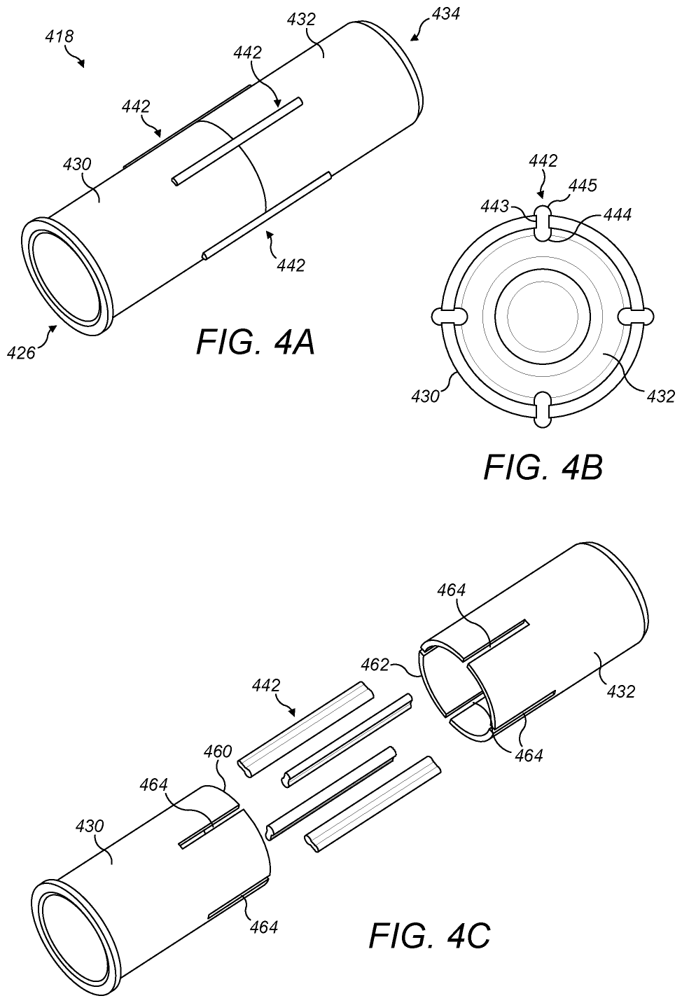

The figures herein follow a numbering convention in which the first digit or digits correspond to the drawing figure number and the remaining digits identify an element or component in the drawing. Similar elements or components between different figures may be identified by the use of similar digits. For example, 306 may reference element “06” in FIG. 3, and a similar element may be referenced as 406 in FIG. 4. The skilled person will appreciate that the description of the properties and configuration of each element may equally apply to corresponding elements in other embodiments.

As described herein, a vapour is generally understood to refer to a substance in the gas phase at a temperature lower than its critical temperature, which means that the vapour can be condensed to a liquid by increasing its pressure without reducing the temperature, whereas an aerosol is a suspension of fine solid particles or liquid droplets, in air or another gas. It should, however, be noted that the terms ‘aerosol’ and ‘vapour’ may be used interchangeably in this specification, particularly with regard to the form of the inhalable medium that is generated for inhalation by a user.

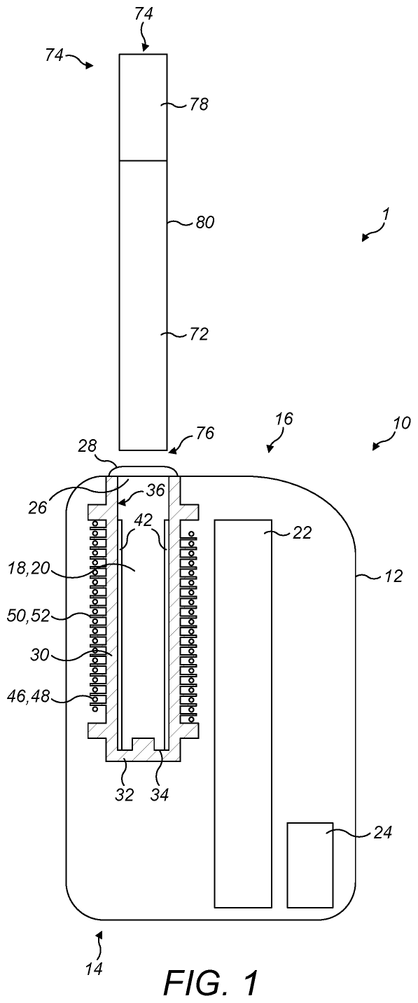

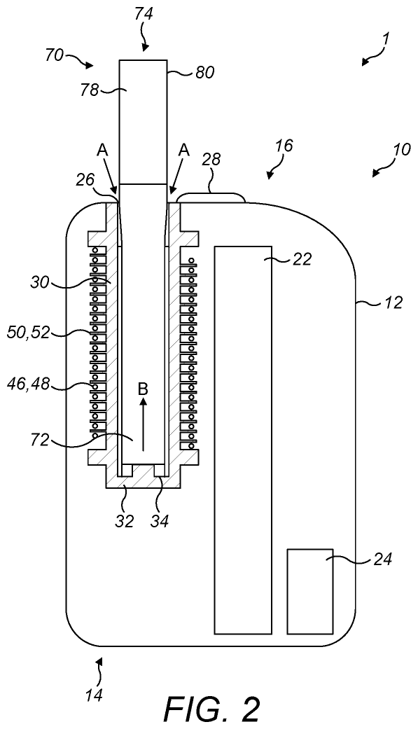

Referring initially to FIGS. 1 and 2, there is shown diagrammatically an example of an aerosol generating system 1. The aerosol generating system 1 comprises an aerosol generating device 10 and an aerosol generating article 70 for use with the device 10.

The aerosol generating article 70 comprises an aerosol generating substrate 72, such as tobacco. The aerosol generating device 10 is configured to heat, without burning, the aerosol generating article 70 to form an aerosol from the aerosol generating substrate 72 for inhalation by user of the device 10.

The aerosol generating device 10 comprises a main body 12 housing various components of the aerosol generating device 10. The main body 12 can have any shape that is sized to fit the components described in the various embodiments set out herein and to be comfortably held by a user unaided, in a single hand.

A first end 14 of the aerosol generating device 10, shown towards the bottom of FIGS. 1 and 2, is described for convenience as a distal, bottom, base or lower end of the aerosol generating device 10. A second end 16 of the aerosol generating device 10, shown towards the top of FIGS. 1 and 2, is described as a proximal, top or upper end of the aerosol generating device 10. During use, the user typically orients the aerosol generating device 10 with the first end 14 downward and/or in a distal position with respect to the user's mouth and the second end 16 upward and/or in a proximate position with respect to the user's mouth.

The aerosol generating device 10 comprises a heating chamber 18 positioned in the main body 12. The heating chamber 18 defines an interior volume in the form of a cavity 20 having a substantially tubular cross-section, e.g. cylindrical, for receiving an aerosol generating article 70. The heating chamber 18 has a longitudinal axis defining a longitudinal direction. The aerosol generating device 10 further comprises a power source 22, for example one or more batteries which may be rechargeable, and a controller 24.

The heating chamber 18 is open towards the second end 16 of the aerosol generating device 10. In other words, the heating chamber 18 has an open end 26 towards the second end 16 of the aerosol generating device 10. The heating chamber 18 is typically held spaced apart from the inner surface of the main body 12 to minimise heat transfer to the main body 12. The heating chamber 18 typically has a closed end 34 opposite the open end 26.

The aerosol generating device 10 can optionally include a sliding cover 28 movable transversely between a closed position (see FIG. 1) in which it covers the open end 26 of the heating chamber 18 to prevent access to the heating chamber 18 and an open position (see FIG. 2) in which it exposes the open end 26 of the heating chamber 18 to provide access to the heating chamber 18. The sliding cover 28 can be biased to the closed position in some embodiments.

The heating chamber 18, and specifically the cavity 20, is arranged to receive a correspondingly shaped aerosol generating article 70. For instance, in this example the heating chamber 18 is arranged to receive a generally cylindrical or rod-shaped aerosol generating article 70. Thus, the heating chamber 18 is tubular, e.g. substantially cylindrical. However, the skilled person will appreciate that the shape of the heating chamber 18 may vary.

Typically, the aerosol generating article 70 comprises a pre-packaged aerosol generating substrate 72. The aerosol generating article 70 is a disposable and replaceable article (also known as a “consumable”) which may, for example, contain tobacco as the aerosol generating substrate 72. The aerosol generating article 70 has a proximal end 74 (or mouth end) and a distal end 76. The aerosol generating article 70 further comprises a mouthpiece segment 78 positioned downstream of the aerosol generating substrate 72. The aerosol generating substrate 72 and the mouthpiece segment 78 are arranged in coaxial alignment inside a wrapper 80 (e.g., a paper wrapper) to hold the components in position to form the rod-shaped aerosol generating article 70.

The mouthpiece segment 78 can comprise one or more of the following components (not shown in detail) arranged sequentially and in co-axial alignment in a downstream direction, in other words from the distal end 76 towards the proximal (mouth) end 74 of the aerosol generating article 70: a cooling segment, a centre hole segment and a filter segment. The cooling segment typically comprises a hollow paper tube having a thickness which is greater than the thickness of the wrapper 80. The centre hole segment may comprise a cured mixture containing cellulose acetate fibres and a plasticizer, and functions to increase the strength of the mouthpiece segment 78. The filter segment typically comprises cellulose acetate fibres and acts as a mouthpiece filter. As heated vapour flows from the aerosol generating substrate 72 towards the proximal (mouth) end 74 of the aerosol generating article 70, the vapour cools and condenses as it passes through the cooling segment and the centre hole segment to form an aerosol with suitable characteristics for inhalation by a user through the filter segment.

The heating chamber 18 comprises a first casing member 30, a second casing member 32 and one or more inductively heatable susceptors 42 which cooperatively engage to form the heating chamber 18 and define the interior volume of the heating chamber 18. The configuration of the heating chamber 18 will be discussed in further detail later with reference to FIGS. 3 to 12.

The aerosol generating device 10 comprises an electromagnetic field generator 46 for generating an electromagnetic field. The electromagnetic field generator 46 comprises a substantially helical induction coil 48. The induction coil 48 has a circular cross-section and extends helically around the tubular heating chamber 18. The induction coil 48 can be energised by the power source 22 and controller 24. The controller 24 includes, amongst other electronic components, an inverter which is arranged to convert a direct current from the power source 22 into an alternating high-frequency current for the induction coil 48.

An outer wall of heating chamber 18 may include a coil support structure 50 formed in the outer surface. In the illustrated example, the coil support structure 50 comprises a coil support groove 52 which extends helically around the outer surface of the heating chamber 18. The induction coil 48 is positioned in the coil support groove 52 and is, thus, securely and optimally positioned with respect to the inductively heatable susceptors 42.

In order to use the aerosol generating device 10, a user displaces the sliding cover 28 (if present) from the closed position shown in FIG. 1 to the open position shown in FIG. 2. The user then inserts an aerosol generating article 70 through the open end 26 into the heating chamber 18, so that the aerosol generating substrate 72 is received in the cavity 20 and so that the proximal end 74 of the aerosol generating article 70 is positioned at the open end 26 of the heating chamber 18, with at least part of the mouthpiece segment 78 projecting from the open end 26 to permit engagement by a user's lips.

Upon activation of the aerosol generating device 10 by a user, the induction coil 48 is energised by the power source 22 and controller 24 which supply an alternating electrical current through to the induction coil 48, and an alternating and time-varying electromagnetic field is thereby produced by the induction coil 48. This couples with the inductively heatable susceptors 42 and generates eddy currents and/or magnetic hysteresis losses in the susceptors 42 causing them to heat up. The heat is then transferred from the inductively heatable susceptors 42 to the aerosol generating substrate 72, for example by conduction, radiation and convection. This results in heating of the aerosol generating substrate 72 without combustion or burning, and a vapour is thereby generated. The generated vapour cools and condenses to form an aerosol which can be inhaled by a user of the aerosol generating device 10 through the mouthpiece segment 78, and more particularly through the filter segment.

The vaporisation of the aerosol generating substrate 72 is facilitated by the addition of air from the surrounding environment, for example through the open end 26 of the heating chamber 18, the airflow air being heated as it flows between the wrapper 80 of the aerosol generating article 70 and an inner surface 36 of the heating chamber 18. More particularly, when a user sucks on the filter segment, air is drawn into the heating chamber 18 through the open end 26 as illustrated by the arrows A in FIG. 2. The air entering the heating chamber 18 flows from the open end 26 towards the closed end 34 of the heating chamber 18, between the aerosol generating substrate 72 and the inner surface 36 of the heating chamber 18.

When the air reaches the closed end 34 of the heating chamber 18, it turns through approximately 180° and enters the distal end 76 of the aerosol generating article 70. The air is then drawn through the aerosol generating article 70 as illustrated by the arrow B in FIG. 2, from the distal end 76 towards the proximal (mouth) end 74 along with the generated vapour.

A user can continue to inhale aerosol all the time that the aerosol generating substrate 72 is able to continue to produce a vapour, e.g. all the time that the aerosol generating substrate 72 has vaporisable components left to vaporise into a suitable vapour. The controller 24 may adjust the magnitude of the alternating electrical current passed through the induction coil 48 to ensure that the temperature of the inductively heatable susceptors 42, and in turn the temperature of the aerosol generating substrate 72, does not exceed a threshold level. Specifically, at a particular temperature, which depends on the constitution of the aerosol generating substrate 72, the aerosol generating substrate 72 will begin to burn. This is not a desirable effect and temperatures above and at this temperature are avoided.

Next, a number of preferred embodiments of the heating chamber 18 will be described with reference to FIGS. 3A to 12B.

FIGS. 3A to 3B show various views of a heating chamber 318 according to an embodiment of the invention. FIG. 3A is a perspective view of the heating chamber 318, FIG. 3B is view looking down an open end 326 of the heating chamber 318, and FIG. 3C is an exploded view of the heating chamber 318.

The heating chamber 318 comprises a first casing member 330, a second casing member 332, and a plurality of inductively heatable susceptors 342. The first casing member 330, the second casing member 332, and the plurality of inductively heatable susceptors 342 cooperatively engage to form the heating chamber 318. In particular, the plurality of inductively heatable susceptors 342 are arranged to fasten the first casing member 330 to the second member 332.

The first casing member 330 is tubular, e.g. substantially cylindrical, and has a first longitudinal end 360 having a slotted configuration comprising a plurality of slots 364. The first casing member 330 has an open end 326 opposite to the first longitudinal end 360, through which the aerosol generating article 70 may be received. The second casing member 332 is also tubular, e.g. substantially cylindrical, and has a second longitudinal end 362 having a slotted configuration comprising a plurality of slots 364. The second casing member 332 has a closed end 334 opposite to the second longitudinal end 362. The first casing member 330 and the second casing member 332 are coaxially aligned in a longitudinal direction.

The slotted configuration of the first longitudinal end 360 of the first casing member 330 and the slotted configuration of the second longitudinal end 362 of the second casing member 332 are arranged so that the first longitudinal end 360 of the first casing member 330 and the second longitudinal end 362 of the second casing member 332 substantially engage such that they are rotationally locked with respect to one another. In other words, the first longitudinal end 360 of the first casing member 330 and the second longitudinal end 362 of the second casing member 332 are configured to interdigitate, by virtue of their slotted configurations, to form an integrated tubular body.

Each inductively heatable susceptor 342 is formed as a rod which extends in a direction parallel to a longitudinal direction of the heating chamber 318, i.e. a longitudinal direction of the first casing member 330 and the second casing member 332. The inductively heatable susceptors 342 are spaced around the circumference of the heating chamber 318 and integrated within the wall of the heating chamber 318, i.e. integrated within the walls of the first casing member 330 and the second casing member 332. In particular, the inductively heatable susceptors 342 are respectively located along the longitudinal interfaces formed between the slotted configurations of the first longitudinal end 360 of the first casing member 330 and the second longitudinal end 362 of the second casing member 332. In this way, the inductively heatable susceptors 342 act as fastening elements which couple the first casing member 330 to the second casing member 332, whilst also being optimally located to heat the aerosol generating substrate 72 received within the heating chamber 318.

Each inductively heatable susceptor 342 comprises an inwardly extending portion 344 that protrudes into the heating chamber 318 in a radial direction of the heating chamber 318. In particular, each inwardly extending portion 344 forms an elongate ridge on the respective inductively heatable susceptor 342, the elongate ridge protruding into the interior volume of the heating chamber 318. In this example, each inwardly extending portion 344 is present along the entire length of the respective inductively heatable susceptor 342. However, the skilled person will appreciate that, in other embodiments, the inwardly extending portion 344 may only be present along a portion of the length of each of inductively heatable susceptor 342. The inwardly extending portions 344 provide a reduced cross-sectional area of the heating chamber 318. That is, the inwardly extending portions 344 extend away from the inner wall of the first casing member 330 and second casing member 332, in an inward direction of the heating chamber 318. Advantageously, the inwardly extending portions 344 may form a friction fit with the aerosol generating substrate 72 received within the heating chamber 318, thereby providing a compressive force on the aerosol generating substrate 72. By compressing the aerosol generating substrate 72, heat can be transferred more efficiently to the aerosol generating substrate 72 and more rapid heating can be achieved, whilst at the same time maximising energy efficiency.

Each inductively heatable susceptor 342 also comprises an outwardly extending portion 345. The outwardly extending portion 345 runs along the length of the respective rod of inductively heatable susceptor 342, thereby forming an elongate ridge that protrudes away from the first casing member 330 and the second casing member 332 in an outward radial direction. The outwardly extending portion 345 and the inwardly extending portion 344 define notches 343 extending along either side of the length of the inductively heatable susceptor 342. The longitudinal interfaces of the slotted configurations of the first casing member 330 and the second member 332 are located within the respective notches 343 on either side of the inductively heatable susceptor 342. In this way, the constraint provided by the combination of the outwardly extending portion 345 and the inwardly extending portion 344 ensures that first casing member 330 and the second casing member 332 are retained within respective notches 343 of the inductively heatable susceptor 342, thereby fastening the first casing member 330 to the second casing member 332.

The first casing member 330 and the second casing member 332 may comprise a substantially non-electrically conductive and non-magnetically permeable material. For example, the first casing member 330 and the second casing member 332 may comprise a heat-resistant plastics material, such as polyether ether ketone (PEEK). The first casing member 330 and the second casing member 332 themselves are not heated by the induction coil 48 (not shown) during operation of the aerosol generating device 10, ensuring that energy input into the inductively heatable susceptors 342 is maximised. This in turn helps to ensure that the energy efficiency of the device 10 is maximised. The device also remains cool to the touch, ensuring that user comfort is maximised.

The inductively heatable susceptors 342 comprise a metal suitable for being inductively heated. The metal is typically selected from the group consisting of stainless steel and carbon steel. The inductively heatable susceptors 342 could, however, comprise any suitable material including one or more, but not limited, of aluminium, iron, nickel, stainless steel, carbon steel, and alloys thereof, e.g. nickel chromium or nickel copper. With the application of an electromagnetic field in its vicinity, each inductively heatable susceptor 342 generates heat due to eddy currents and magnetic hysteresis losses resulting in a conversion of energy from electromagnetic to heat. In this way, the aerosol generating substrate 72 received within the heating chamber 318 may be heated by the inductively heatable susceptors 342 to produce an aerosol.

The skilled person will appreciate that these material properties apply equally to the other embodiments of the heating chamber described herein.

In the depicted embodiment, the first casing member 330 and the second casing member 332 each comprise two slots 364 that are evenly spaced apart around the circumference of the first casing member 330 and the second casing member 332 respectively. The heating chamber 318 consequently comprises four inductively heatable susceptors 342 evenly spaced around the circumference of the heating chamber 318, corresponding to the longitudinal interfaces between the first longitudinal end 360 of the first casing member 330 and the second longitudinal end 362 of the second casing member 332. However, the skilled person will appreciate that the number of slots 364, and thus the number of inductively heatable susceptors 342, may vary.

It will also be appreciated by the skilled person that the outer surface of the first casing member 330 and the second casing member 332 may be configured to support or receive the induction coil 48, as described with reference to FIGS. 1 and 2.

FIGS. 4A to 4B show various views of a heating chamber 418 according to another embodiment of the invention. FIG. 4A is a perspective view of the heating chamber 418, FIG. 4B is view looking down an open end 426 of the heating chamber 418, and FIG. 4C is an exploded view of the heating chamber 418.

Again, the heating chamber 418 comprises a first casing member 430, a second casing member 432, and a plurality of inductively heatable susceptors 442. The first casing member 430, the second casing member 432, and the plurality of inductively heatable susceptors 442 cooperatively engage to form the heating chamber 418 by virtue of the plurality of inductively heatable susceptors 442 which are arranged to fasten the first casing member 430 to the second member 432.

The first casing member 430 is tubular, e.g. substantially cylindrical, and has a first longitudinal end 460 having a slotted configuration comprising a plurality of slots 464. The first casing member 430 has an open end 426 opposite to the first longitudinal end 460. The second casing member 432 is also tubular, e.g. substantially cylindrical, and has a second longitudinal end 462 having a slotted configuration comprising a plurality of slots 464. The second casing member 432 has a closed end 434 opposite to the second longitudinal end 362.

However, in this embodiment, the slotted configurations of the first casing member 430 and the second casing member 432 are not configured to directly interlock. Instead, the first casing member 430 and the second casing member 432 are coaxially aligned with the first longitudinal end 460 of the first casing member 430 adjacent to the second longitudinal end 462 of the second casing member 432 such that the slots 464 of the first longitudinal end 460 of the first casing member 430 align with respective slots 464 of the second longitudinal end 462 of the second casing member 432. The inductively heatable susceptors 442 are elongate rods which are located within each pair of aligned slots 464. That is, the inductively heatable susceptors 442 extend between corresponding slot 464 of the first casing member 430 and the second casing member 432, thereby fastening the first casing member 430 to the second casing member 432.

In particular, the inductively heatable susceptors 442 are securely seated within respective slots 443 by virtue of the respective notches 443 defined between the inwardly extending portion 444 and the outwardly extending portion 445 of each inductively heatable susceptor 442. That is, the constraint imposed by the inwardly extending portions 444 prevents the inductively heatable susceptors 442 being moved in a radially outward direction, whereas the constraint imposed by the outwardly extending portion 445 prevents the inductively heatable susceptors 442 being moved in a radially inward direction.

In the depicted embodiment, the first casing member 430 and the second casing member 432 each comprise four slots 464 that are evenly spaced apart around the circumference of the first casing member 430 and the second casing member 432 respectively. The heating chamber 318 consequently comprises four inductively heatable susceptors 442 evenly spaced around the circumference of the heating chamber 318, situated within each pair of aligned slots 464. However, the skilled person will appreciate that the number of slots 464, and the corresponding number of inductively heatable susceptors 442, may vary.

The skilled person will appreciate that other aspects of the configuration of the inductively heatable susceptors 342, the first casing member 330 and the second casing member 332 of FIGS. 3A to 3C apply equally to the inductively heatable susceptors 442, the first casing member 430 and the second casing member 432 of FIGS. 4A to 4C. For example, the inductively heatable susceptors 442 comprise inwardly extending portions 444 which correspond to the inwardly extending portions 344.

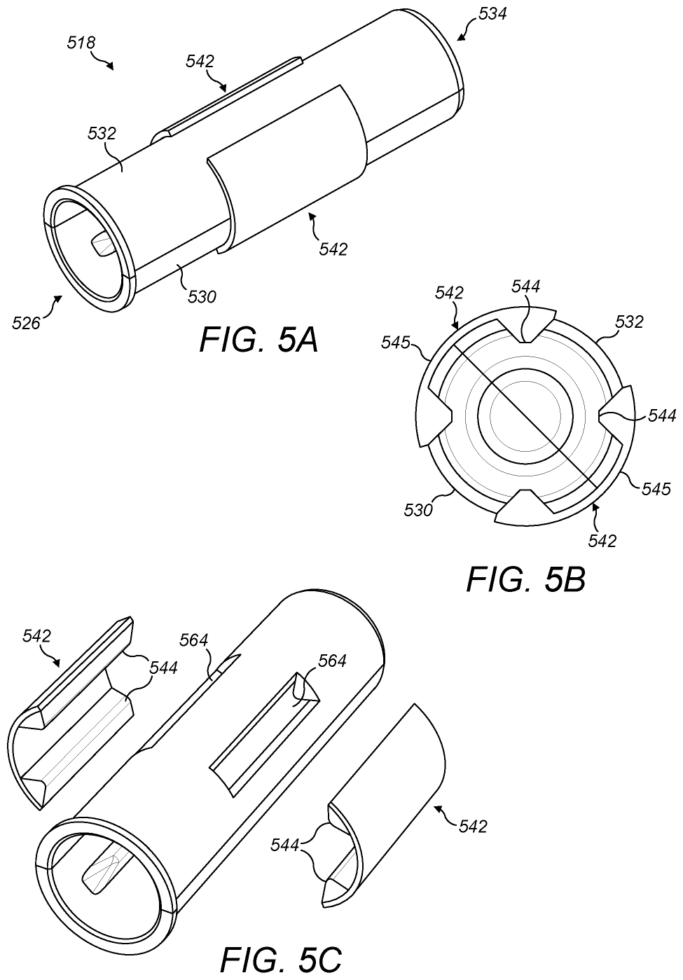

FIGS. 5A to 5C show various views of a heating chamber 518 according to another embodiment of the invention. FIG. 5A is a perspective view of the heating chamber 518, FIG. 5B is a view looking down an open end 526 of the heating chamber 518, and FIG. 5C is an exploded view of the heating chamber 518.

The heating chamber 518 comprises a first casing member 530, a second casing member 532, and a plurality of inductively heatable susceptors 542. The first casing member 530, the second casing member 532, and the plurality of inductively heatable susceptors 542 cooperatively engage to form the heating chamber 518. In particular, the plurality of inductively heatable susceptors 542 are arranged to clamp the first casing member 530 to the second member 532.

The first casing member 530 and the second casing member 532 are arranged to engage along their longitudinal edges to form a tubular body, e.g. a cylinder. Specifically, in the depicted embodiment, the first casing member 530 and the second casing member 532 are formed as tubular half-sections, which join together along their length to form the heating chamber 518. However, the skilled person will appreciate that the number and shape of casing members may be varied.

Each inductively heatable susceptor 542 is formed as a curved plate which extends around a portion of the exterior of the first casing member 530 and the second casing member 532 to couple the first casing member 530 to the second casing member 532. In particular, each plate of inductively heatable susceptor 542 comprises two inwardly extending portions 544 which respectively slot into (and through) the first casing member 530 and the second casing member 532, thereby clamping the first casing member 530 to the second casing member 532. The inwardly extending portions 544 run parallel to the longitudinal direction of the heating chamber 518 and are located on an inward (i.e. concave) side of the plate of inductively heatable susceptor 542, on opposing edges of the plate.

The first casing member 530 and the second casing member 532 comprise elongate slots 564 configured to receive the inwardly extending portions 544. Specifically, the elongate slots 564 are located adjacent and parallel to respective longitudinal edges of the first casing member 530 and the second casing member 532, thereby providing corresponding slots 564 located either side of the longitudinal joining interface between the first casing member 530 and the second casing member 532. In this way, each inductively heatable susceptor 542 extends between each pair of corresponding slots 564, i.e. between the first casing member 530 and the second casing member 532, to securely fasten the first casing member 530 to the second casing member 532 and form the heating chamber 518. The inwardly extending portions 544 may be described as forming a snap-fit within the respective elongate slots 564.

Advantageously, as each inductively heatable susceptor 542 is formed as a plate which extends around the exterior of the heating chamber 518, the mass of each inductively heatable susceptor 542 that may be inductively heated is increased. In particular, the inductively heatable susceptors 542 have a greater mass closer to the surrounding induction coil 48, such that the inductively heatable susceptors 542 are able to harvest more induction heat. The portions of the plates of inductively heatable susceptor 542 that extend around the exterior of the heating chamber 518 may be referred to as outwardly extending portions 545.

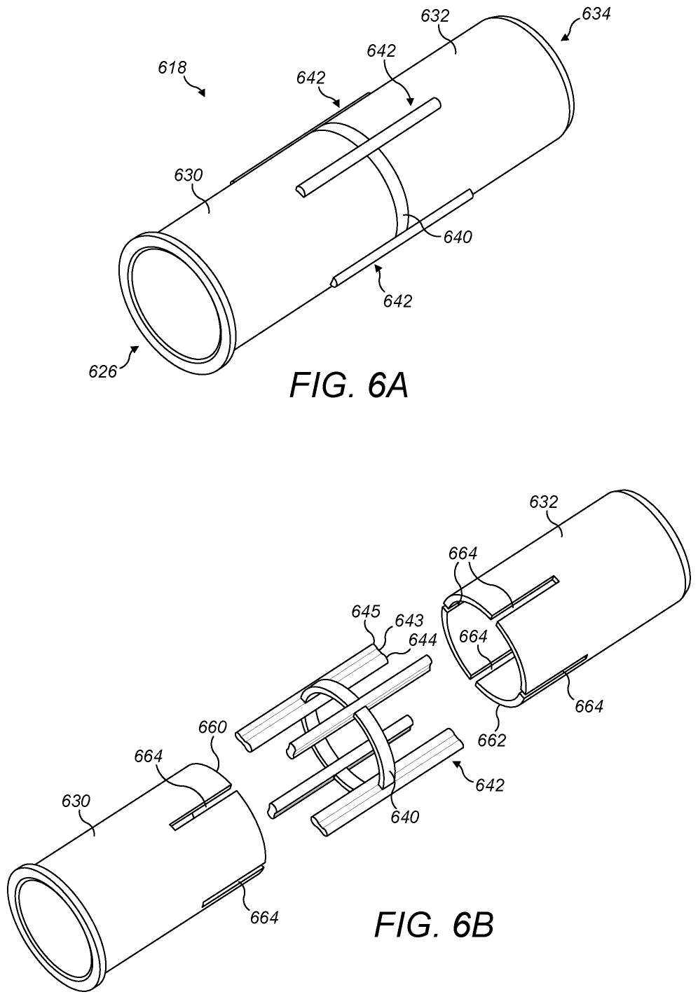

FIGS. 6A and 6B show different views of a heating chamber 618 according to another embodiment of the invention. FIG. 6A is a perspective view of the heating chamber 618 and FIG. 6B is an exploded view of the heating chamber 618.

The configuration of the heating chamber 618 substantially corresponds to the heating chamber 418 described with reference to FIG. 4A to 4C. However, the heating chamber 618 further comprises a ring of inductively heatable susceptor 640 that is disposed between the first longitudinal end 660 of the first casing member 630 and the second longitudinal end 662 of the second casing member 662. Specifically, the ring of inductively heatable susceptor 640 is coaxially aligned between (and with) the first casing member 630 and the second casing member 632.

In the depicted embodiment, the plurality of rods of inductively heatable susceptors 642 and the ring of inductively heatable susceptor 640 are formed as a single (e.g. integrated) component which is configured to fasten the first casing member 630 to the second casing member 632 and provide concentrated heating to the aerosol generating substrate 72 received within the heating chamber 618. However, the skilled person will appreciate that the plurality of rods of inductively heatable susceptors 642 and the ring of inductively heatable susceptor 640 may be formed as separate components.

In the case of the plurality of rods of inductively heatable susceptors 642 and the ring of inductively heatable susceptor 640 being formed as a consolidated unit, the skilled person will appreciate that the respective slots 646 in the first casing member 630 and the second casing member 632 are no longer required to be aligned, and instead may be misaligned.

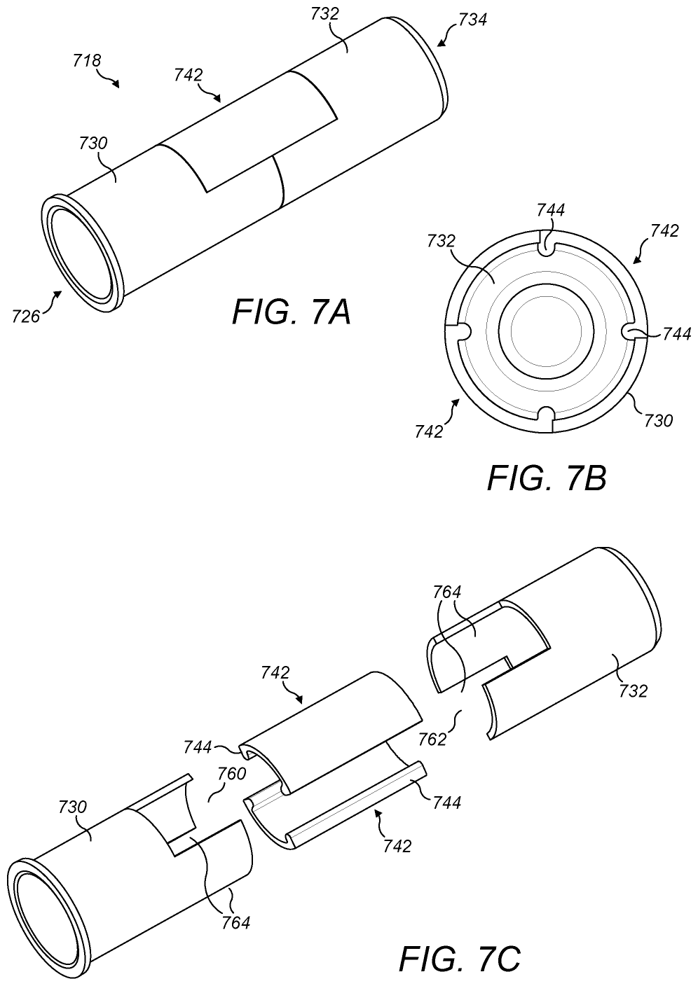

FIGS. 7A to 7C show various views of a heating chamber 718 according to another embodiment of the invention. FIG. 7A is a perspective view of the heating chamber 718, FIG. 7B is view looking down an open end 726 of the heating chamber 718, and FIG. 7C is an exploded view of the heating chamber 718.

The heating chamber 718 comprises a first casing member 730, a second casing member 732 and a plurality of inductively heatable susceptors 742. The configuration of the first casing member 730 and the second casing 732 substantially corresponds to the configuration of the first casing member 330 and the second casing 332 described with reference to FIGS. 3A to 3B. However, in this embodiment, the slotted configurations of the first casing member 330 and the second casing 332 are not arranged to directly engage and interlock. Instead, the slots 764 in the first longitudinal end 760 of the first casing member 730 are aligned with respective slots 764 in the second longitudinal end 762 of the second casing member 732. The inductively heatable susceptors 742 are formed as curved plates which are respectively located within each pair of aligned slots 764. In other words, each inductively heatable susceptor 742 is located within the gap formed between aligned slots of the first longitudinal end 760 of the first casing member 730 and the second longitudinal end 762 of the second casing member 732. In this way, the inductively heatable susceptors 742 extend between (the slots 764 of) the first longitudinal end 760 of the first casing member 730 and the second longitudinal end 762 of the second casing member 732 to fasten the first casing member 730 to the second casing member 732. The inductively heatable susceptors 742 are integrated within the wall of the heating chamber 718, i.e. the inductively heatable susceptors 742 form a portion of the wall of the heating chamber 718. Advantageously, this arrangement provides a large surface area for heating an aerosol generating substrate received within the heating chamber 718, whilst providing a compact and secure heating chamber 718.

The plates of inductively heatable susceptors 742 comprise one or more inwardly extending portions 744. In particular, each inductively heatable susceptor 742 comprises two inwardly extending portions 744 that run parallel to the longitudinal direction of the heating chamber 718 and are disposed on the inner (i.e. concave) surface of the plate of inductively heatable susceptor 742, on opposing edges of the plate. As previously described, the inwardly extending portions 744 provide a reduced cross-sectional area of the heating chamber 718, thereby providing a compressive force on the aerosol generating substrate 72 received within the heating chamber 718.

The plates of inductively heatable susceptors 742 form a snap-fit within respective aligned slots 764, thereby securely fastening the first casing member 730 to the second casing member 732. In particular, each inwardly extending portions 744 comprises a hooked-portion (also referred to as a cantilever) which forms a snap-fit along the respective longitudinal interface of the slotted configurations of the first casing member 730 and the second casing member 732.

In the depicted embodiment, the first casing member 730 and the second casing member 732 each comprise two slots 764 that are evenly spaced apart around the circumference of the first casing member 730 and the second casing member 732 respectively. The heating chamber 718 consequently comprises two inductively heatable susceptors 742 evenly spaced around the circumference of the heating chamber 718, situated within each pair of aligned slots 764. However, the skilled person will appreciate that the number of slots 764, and the corresponding number of inductively heatable susceptors 742, may vary.

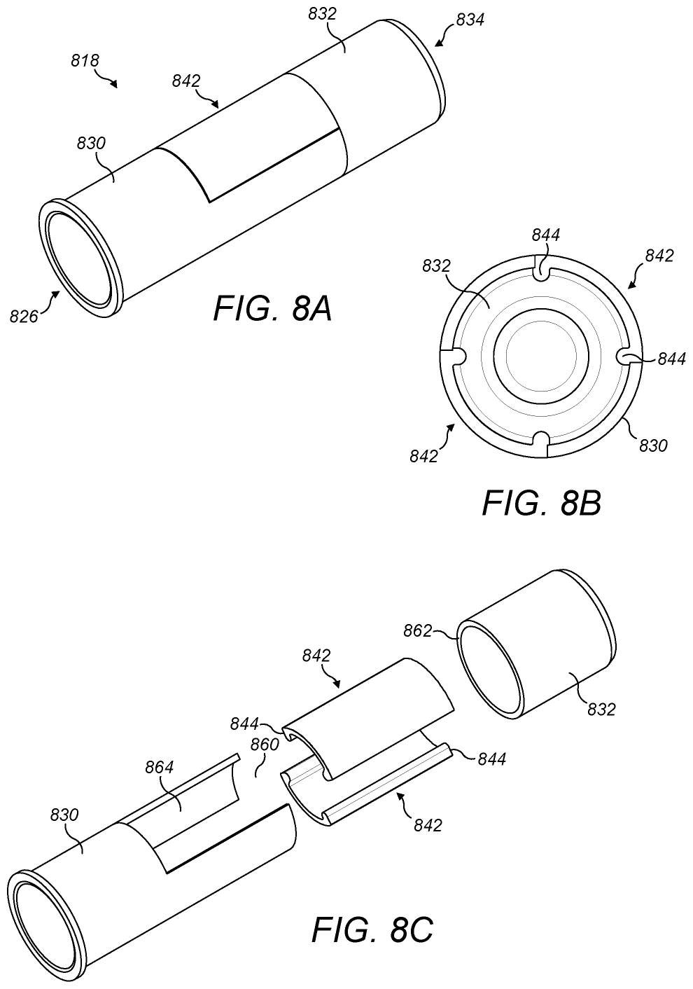

FIGS. 8A to 8C show various views of a heating chamber 818 according to another embodiment of the invention. FIG. 8A is a perspective view of the heating chamber 818, FIG. 8B is view looking down an open end 826 of the heating chamber 818, and FIG. 8C is an exploded view of the heating chamber 818.

The heating chamber 818 comprises a first casing member 830, a second casing member 832 and a plurality of inductively heatable susceptors 842. The configuration of the first casing member 830 and the inductively heatable susceptors 842 substantially corresponds to the configuration of the first casing member 730 and the inductively heatable susceptors 742 described with reference to FIGS. 7A to 7B. However, in this embodiment, the second casing member 832 does not have a slotted configuration, i.e. there are no slots in the second longitudinal end 862 of the second casing member 832. Instead, the second casing member 832 is formed as a complete cylindrical tube.

The curved plates of inductively heatable susceptor 842 are located entirely within respective slots 864 of the first longitudinal end 860 of the first casing member 830. That is, the inductively heatable susceptors 842 are integrated within the wall of the first casing member 830 at locations corresponding to the slots 864. The inductively heatable susceptors 842 do not extend into the second casing member 832.

Each plate of inductively heatable susceptor 842 forms a snap-fit within the respective slot 864. In particular, each inwardly extending portion 844 comprises a hooked-portion (also referred to as a cantilever) which forms a snap-fit along the respective longitudinal interface of the slotted configuration of the first casing member 830.

The second longitudinal end 862 of the second casing member 832 is coaxially aligned with the first longitudinal end 860 of the first casing member 830 such that the second longitudinal end 862 of the second casing member 832 forms an interface with the first longitudinal end 860 of the first casing member 830 and a longitudinal end of each inductively heatable susceptor 842. The second longitudinal end 862 of the second casing member 832 may be joined to the first longitudinal end 860 of the first casing member 830 and the inductively heatable susceptors 842 using any suitable fastening mechanism, such as a screw, bolt or adhesive.

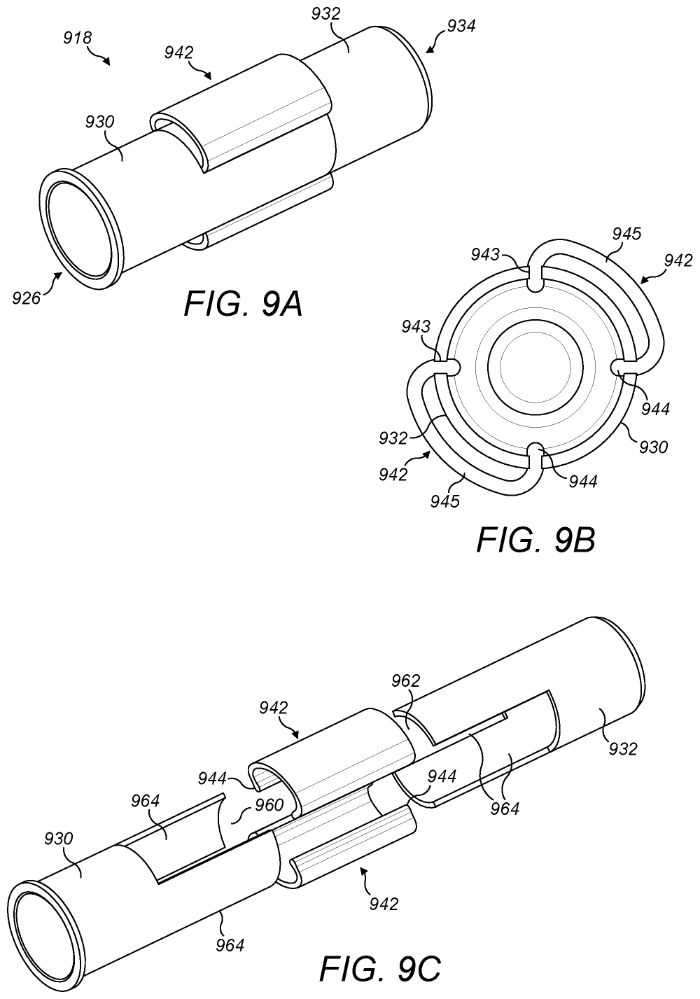

FIGS. 9A to 9C show various views of a heating chamber 918 according to another embodiment of the invention. FIG. 9A is a perspective view of the heating chamber 918, FIG. 9B is view looking down an open end 926 of the heating chamber 918, and FIG. 9C is an exploded view of the heating chamber 918.

The heating chamber 918 comprises a first casing member 930, a second casing member 932 and a plurality of inductively heatable susceptors 942. The configuration of the first casing member 930 and the second casing 932 substantially corresponds to the configuration of the first casing member 330 and the second casing 332 described with reference to FIGS. 3A to 3B. That is, the first longitudinal end 960 of the first casing member 930 and the second longitudinal end 962 of the second casing member 932 have complementary slotted configurations such that the first longitudinal end 960 of the first casing member 930 substantially engages with the second longitudinal end 962 of the second casing member 932 so that they are rotationally locked with respect to one another.

However, in this embodiment, the inductively heatable susceptors 942 are formed as curved or “C” shaped plates which are arranged such that the plates extend around a portion of the exterior of the first casing member 930 and the second casing member 932 respectively. In particular, each inductively heatable susceptor 942 comprises inwardly extending portions 944 which are respectively located within (and extend through) the longitudinal interfaces formed between the slotted configurations of the first longitudinal end 960 of the first casing member 930 and the second longitudinal end 962 of the second casing member 932. In this way, the inductively heatable susceptors 942 act as fastening elements which couple the first casing member 930 to the second casing member 932.

Specifically, each plate of inductively heatable susceptor 942 comprises two inwardly extending portions 944 which run in a direction parallel to the longitudinal axis of the heating chamber 918 and are located on an inward (i.e. concave) side of the plate of inductively heatable susceptor 542, on opposing edges of the plate. In a cross-sectional view, the inwardly extending portions 944 are seen to correspond to the tips of the “C” shaped plate of inductively heatable susceptor 942. Each inductively heatable susceptors 942 may be described as having two arms, each arm comprising a respective inwardly extending portions 944.

The portion of the plates of inductively heatable susceptor 942 that extend around the exterior of the heating chamber 921 may be described as outwardly extending portions 945. That is, the outwardly extending portions 945 are outwardly displaced from the wall of the first casing member 930 and the second casing member 932. Advantageously, this provides a greater mass of the inductively heatable susceptors 945 situated in close proximity to the surrounding induction coil 48, thereby increasing the capability of the inductively heatable susceptors 945 to be inductively heated.

Each inwardly extending portion 944 and outwardly extending portion 945 are configured to define notches 943 extending along either side of each arm of the inductively heatable susceptor 942. The longitudinal interfaces of the slotted configurations of the first casing member 930 and the second member 932 are located within the respective notches 943 on either side of each arm of the inductively heatable susceptor 942. In this way, the constraint provided by the combination of the outwardly extending portion 945 and the inwardly extending portion 944 ensures that first casing member 930 and the second casing member 932 are retained within respective notches 943 of the inductively heatable susceptor 942, thereby fastening the first casing member 930 to the second casing member 932.

In the depicted embodiment, the plates of inductively heatable susceptor 942, and in particular the outwardly extending portions 945, are displaced away from the walls of the first casing member 930 and the second casing member 932 around the exterior of the heating chamber 918, i.e. there is an air gap between the outwardly extending portions 945 and the outer surface of the first casing member 930 and the second casing member 932. However, the skilled person will appreciate that, in alternative embodiments, the plates of inductively heatable susceptor 942 may directly interface, i.e. lie flush, with the respective outer surfaces of the first casing member 930 and the second casing member 932.

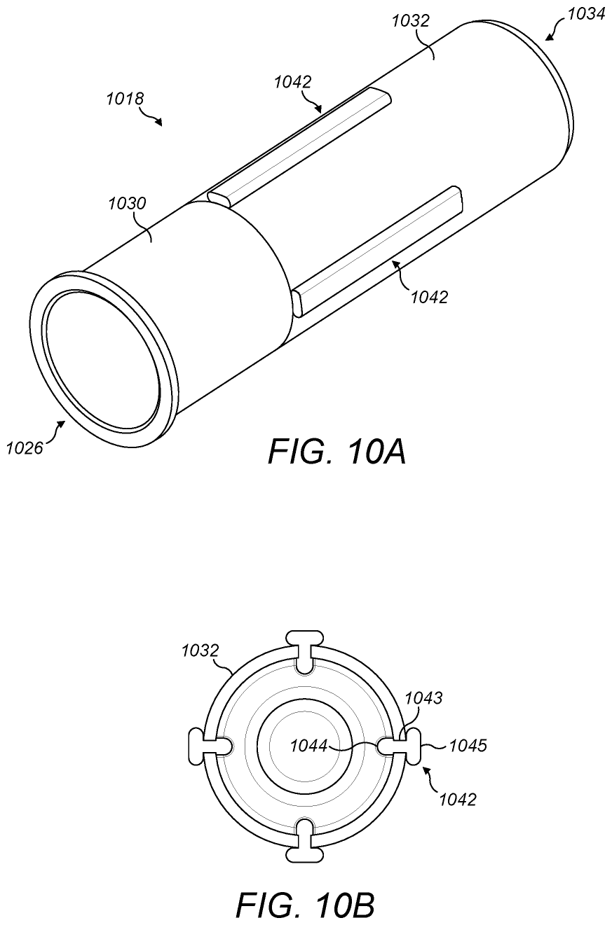

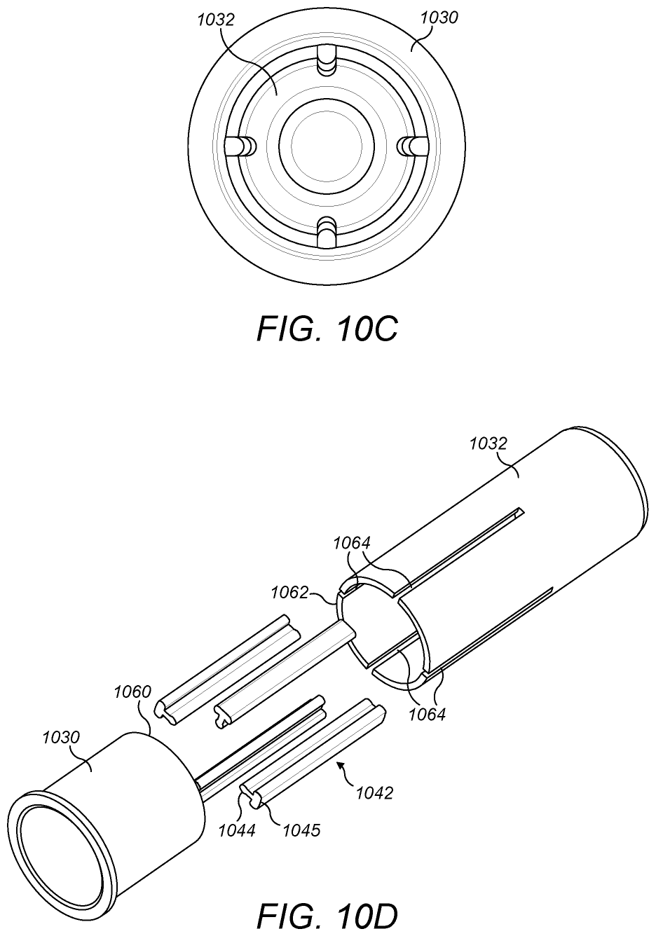

FIGS. 10A to 10D show various views of a heating chamber 1018 according to another embodiment of the invention. FIG. 10A is a perspective view of the heating chamber 1018, FIG. 10B is a view looking down a second longitudinal end 1062 of a second casing member 1032, FIG. 100 is view looking down an open end 1026 of the heating chamber 1018, and FIG. 10D is an exploded view of the heating chamber 1018.

The heating chamber 1018 comprises a first casing member 1030, a second casing member 1032 and a plurality of inductively heatable susceptors 1042. The configuration of the first casing member 1030 and the inductively heatable susceptors 1042 substantially corresponds to the configuration of the first casing member 430 and the inductively heatable susceptors 442 described with reference to FIGS. 4A to 4B. However, in this embodiment, the first casing member 1032 does not have a slotted configuration, i.e. there are no slots in the first longitudinal end 1060 of the first casing member 1030. Instead, the first casing member 1032 is formed as a complete cylindrical tube.

The elongate rods of inductively heatable susceptor 1042 are located entirely within respective slots 1064 of the second longitudinal end 1062 of the second casing member 1032. That is, the inductively heatable susceptors 1042 are integrated within the wall of the second casing member 1032 at locations corresponding to the slots 1064. The inductively heatable susceptors 1042 do not extend into the first casing member 1030.

The first longitudinal end 1060 of the first casing member 1030 is coaxially aligned with the second longitudinal end 1062 of the second casing member 1032 such that the first longitudinal end 1060 of the first casing member 1030 forms an interface with the second longitudinal end 1062 of the second casing member 1032 and a longitudinal end of each rod of inductively heatable susceptor 1042. The first longitudinal end 1060 of the first casing member 1030 may be joined to the second longitudinal end 1062 of the second casing member 1032 and the inductively heatable susceptors 1042 using any suitable fastening mechanism, such as a screw, bolt or adhesive.

In addition, in this embodiment, each inductively heatable susceptor 1042 comprises an outwardly extending portion 1045. The outwardly extending portions 1045 run along the length of respective rods of inductively heatable susceptor 1042, thereby forming an elongate ridge that protrudes away from the first casing member 1030 and the second casing member 1032 in a radial direction. In this way, a greater mass of the inductively heatable susceptors 1045 is provide in close proximity to the surrounding induction coil 48, thereby increasing the capability of the inductively heatable susceptors 1045 to be inductively heated.

Moreover, the skilled person will appreciate that the inductively heatable susceptors 1042 are securely seated within respective slots 1043 by virtue of the respective notches 1043 defined between the inwardly extending portion 1044 and the outwardly extending portion 1045 of each inductively heatable susceptor 1042. That is, the constraint imposed by the inwardly extending portions 1044 prevents the inductively heatable susceptors 1042 being moved in a radially outward direction, whereas the constraint imposed by the outwardly extending portion 1045 prevents the inductively heatable susceptors 1042 being moved in a radially inward direction.

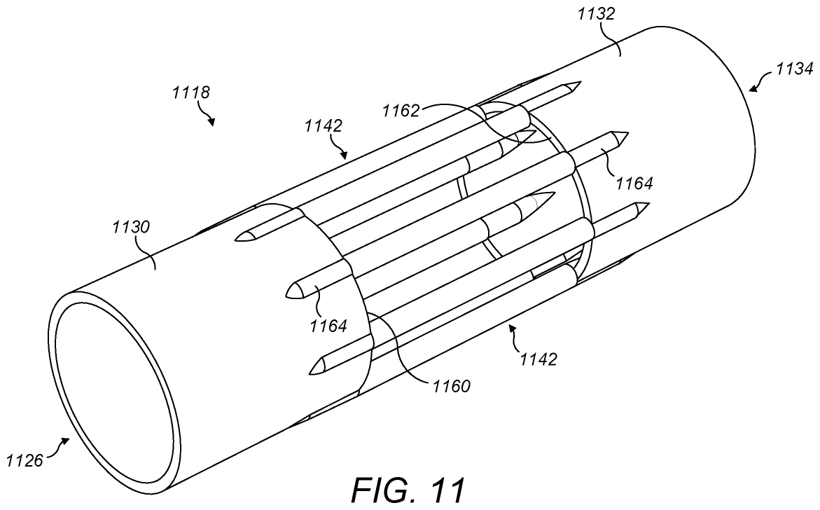

FIG. 11 is a perspective view of a heating chamber 1118 according to another embodiment of the invention. The heating chamber 1118 comprises a first casing member 1130, a second casing member 1132, and a plurality of inductively heatable susceptors 1142.

The first casing member 1130 is tubular and comprises a plurality of slots 1164 circumferentially spaced around a first longitudinal end 1160 of the first casing member 1130. Similarly, the second casing member 1130 is tubular and comprises a plurality of slots 1164 circumferentially spaced around a second longitudinal end 1162 of the second casing member 1132. The plurality of inductively heatable susceptors 1142 are formed as elongate rods which extend in a direction parallel to the longitudinal direction of the heating chamber 1188. Specifically, the inductively heatable susceptors 1142 are substantially cylindrical rods, but the skilled person will appreciate that their shape may vary.

The first casing member 1130 and the second casing member 1132 are coaxially aligned but spatially separated. In particular, the slots 1164 in the first longitudinal end 1160 of the first casing member 1130 are aligned with the slots 1164 in the second longitudinal end 1162 of the second casing member 1132, and the plurality of inductively heatable susceptors 1142 extend between the aligned slots 1164. Opposing ends of the inductively heatable susceptors 1142 are situated within opposing slots 1164. In this way, a plurality of air gaps are provided between the rods of inductively heatable susceptors 1142, thereby allowing increased airflow into the interior of the heating chamber 1188.

In this embodiment, the slots 1164 may be referred to as sockets, as the slots 1164 are formed as cylindrical cavities which provide constraint around the entire circumference of the end of each rod of inductively heatable susceptor 1142. The inductively heatable susceptors 1142 may be removably inserted into respective slots 1164. That is, the inductively heatable susceptor 1142 are detachable from the first casing member 1130 and the second casing member 1132 by sliding the rods of inductively heatable susceptor 1142 in/out of the slots 1164, in a longitudinal direction. In this way, the inductively heatable susceptors 1142 may be removed and/or replaced during the lifetime of the heating chamber 1118.

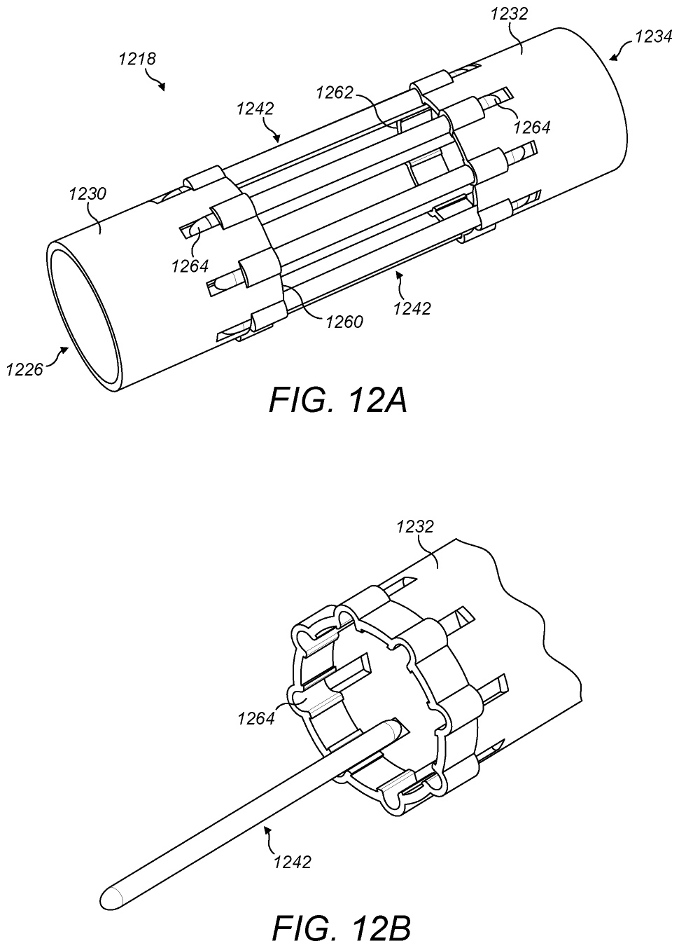

FIGS. 12A and 12B show different views of a heating chamber 1218 according to another embodiment of the invention. FIG. 12A is a perspective view of the heating chamber 1218 and FIG. 12B is a perspective view of the heating chamber 1218 showing only the second casing member 1232 and one inductively heatable susceptor 1242 for the purposes of illustration.

The heating chamber 1218 comprises a first casing member 1230, a second casing member 1232, and a plurality of inductively heatable susceptors 1242. Such components have a configuration that substantially corresponds to the configuration of the heating chamber 1118 described with reference to FIG. 11. However, in this embodiment, the slots 1264 are formed as indentations on the circumferential inner surface of the first longitudinal end 1260 of the first casing member 1230 and the second longitudinal end 1262 of the second casing member 1232. The indentations are configured to receive a complementary shaped inductively heatable susceptor 1242, which may be pressed into the indentation in an outwardly radial direction to form a friction fit. Equally, the inductively heatable susceptor 1242 may be extracted from the indentation by a force applied in an inwardly radial direction. This may be referred to as a “click-in/click-out” mechanism. The inductively heatable susceptors 1242 may also be slid into or out of the slots 1264 in a longitudinal direction of the first casing member 1230 and the second casing member 1232, similar to the embodiment described with reference to FIG. 11.

In this way, the inductively heatable susceptors 1242 are detachable from the first casing member 1230 and the second casing member 1232. The skilled person will appreciate that the heating chambers of the other embodiments may also be configured such that the inductively heatable susceptors are detachable from the first casing member and/or the second casing member.

1. A heating apparatus for an aerosol generating device, comprising:
a first casing member;
a second casing member; and
one or more inductively heatable susceptors, wherein the first casing member, the second casing member and the one or more inductively heatable susceptors cooperatively engage to form a tubular heating chamber for receiving at least part of an aerosol generating substrate, wherein the one or more inductively heatable susceptors are arranged to couple the first casing member to the second casing member.

2. The heating apparatus of claim 1, wherein the one or more inductively heatable susceptors are arranged as fastening elements which couple the first casing member to the second casing member.

3. The heating apparatus of claim 1, wherein the one or more inductively heatable susceptors engage with the first casing member and the second casing member such that the first casing member, the second casing member and the one or more inductively heatable susceptors are rotationally locked with respect to one another.

4. The heating apparatus of claim 1, wherein the one or more inductively heatable susceptors are formed as elongate rods that are integrated within a wall of the heating chamber, wherein the one or more inductively heatable susceptors are spaced around the heating chamber and extend in a direction that is parallel to a longitudinal axis of the heating chamber.

5. The heating apparatus of claim 1, wherein the one or more inductively heatable susceptors are formed as curved plates that are integrated within a wall of the heating chamber, wherein the one or more inductively heatable susceptors are spaced around the heating chamber and extend in direction that is parallel to a longitudinal axis of the heating chamber.

6. The heating apparatus of claim 1, wherein the one or more inductively heatable susceptors respectively comprise at least one inwardly extending portion that protrudes into the heating chamber to provide a reduced cross-sectional area of the heating chamber such that, in use, the aerosol generating substrate received within the heating chamber is compressed.

7. The heating apparatus of claim 1, wherein the one or more inductively heatable susceptors respectively comprise at least one outwardly extending portion that protrudes out of the heating chamber to increase the mass of the one or more inductively heatable susceptors that may be inductively heated.

8. The heating apparatus of claim 1, wherein the first casing member is substantially tubular and comprises a first longitudinal end,
wherein the second casing member is substantially tubular and comprises a second longitudinal end, and
wherein the first casing member and the second casing member are coaxially aligned with the first longitudinal end of the first casing member provided adjacent to the second longitudinal end of the second casing member.

9. The heating apparatus of claim 8, wherein the first longitudinal end of the first casing member has a slotted configuration comprising one or more slots, and
wherein the one or more inductively heatable susceptors are respectively located within the one or more slots.

10. The heating apparatus of claim 9, wherein the second longitudinal end of the second casing member has a slotted configuration comprising one or more slots,
wherein the one or more slots of the first longitudinal end of the first casing member align with the one or more slots of the second longitudinal end of the second casing member, and
wherein the one or more inductively heatable susceptors are respectively located within and extend between each pair of aligned slots to couple the first casing member to the second casing member.

11. The heating apparatus of claim 8, further comprising an inductively heatable susceptor ring that is disposed between the first longitudinal end of the first casing member and the second longitudinal end of the second casing member.

12. The heating apparatus of claim 8, wherein the first longitudinal end of the first casing member and the second longitudinal end of the second casing member have complementary slotted configurations such that the first longitudinal end of the first casing member substantially engages with the second longitudinal end of the second casing member so the first casing member and the second casing member are rotationally locked with respect to one another, and
wherein the one or more inductively heatable susceptors are respectively located along one or more longitudinal interfaces between the complementary slotted configurations.

13. The heating apparatus of claim 1, wherein the first casing member and the second casing member are combinable along their respective lengths to form the heating chamber which is substantially tubular, and
wherein the first casing member and the second casing member are clamped together by the one or more inductively heatable susceptors.

14. The heating apparatus of claim 1, wherein the one or more inductively heatable susceptors are detachable from the first casing member and the second casing member.

15. A method of manufacturing a heating assembly, comprising the steps of:
providing a first casing member;
providing a second casing member;
providing one or more inductively heatable susceptors; and
cooperatively engaging the first casing member, the second casing member and the one or more inductively heatable susceptors to form a tubular heating chamber for receiving at least part of an aerosol generating substrate, wherein the one or more inductively heatable susceptors are arranged to couple the first casing member to the second casing member.
